(19) United States
(12) Patent Application Publication
(10) Pub. No.: US 2003/0125073 A1
(43) Pub. Date: Jul. 3, 2003

(54) System and method for a mobile station to avoid paging loss in multiple mobile networks

(76) Inventors: Hsien-Ming Tsai, Tainan (TW); Shang-Lin Chou, Taipei (TW); Jammy Huang, Taipei (TW)

Correspondence Address: RABIN & CHAMPAGNE, PC, 1101 14TH STREET, NW, SUITE 500, WASHINGTON, DC, 20005, US

(21) Appl. No.: 10/259,442

(22) Filed: Sep. 30, 2002

(30) Foreign Application Priority Data
Dec. 27, 2001 (TW) 090132624

(51) Int. Cl. H04Q 7/20; H04M 1/00; H04B 1/38

(52) U.S. Cl. 455/552; 455/558; 455/458

(57) ABSTRACT

A mobile station simultaneously stands by for multiple mobile networks so that the mobile station can receive paging messages from these mobile networks for responding to incoming calls. Since these mobile networks may not be synchronized, paging occasions of these mobile networks for the mobile phone may be in collision. This results in paging loss. In order to avoid paging loss, the mobile station according to the invention, during cell selection or cell reselection, selects suitable cells whose corresponding paging occasions of the mobile networks are staggered to camp on. Thus, paging messages from the mobile networks are received without paging loss.

This application incorporates by reference Taiwan application Serial No. 090132624, filed on Dec. 27, 2001.

### BACKGROUND OF THE INVENTION

1. Field of the Invention

The invention relates in general to cellular systems, and more particularly to a method and system for a mobile station to avoid paging loss in multiple mobile networks.

2. Description of the Related Art

In the past, a mobile station only has one directory number of a mobile network, and thus a single mobile station is only to access to one mobile network service. If a mobile station is capable of having directory numbers from multiple mobile networks, where the mobile station is referred to as a multi-directory mobile station, a single mobile station could satisfy the following requirements. (1) Call expenses can be divided into business expense and personal expense by using a public directory number for business calls and a private directory number for personal calls in a mobile station. (2) Callers can be distinguished into different groups by using callee directory numbers. (3) Mobile station users have flexibility in selecting different receiving quality, calling rates, and services from different mobile phone service providers. Therefore, multi-directory mobile stations would bring much more convenience to users.

In cellular systems, for example, Global System for Mobile communication (GSM), directory numbers of mobile stations are stored in respective subscriber identity module (SIM) cards. Mobile service providers provide SIM cards for subscribers to insert into the slots of their mobile stations so that the mobile stations have directory numbers to access mobile network services. Nowadays, one SIM card can be equipped with two directory numbers. For example, as shown in FIG. 1A, a mobile phone 200 has one SIM card equipped with two directory numbers. However, this kind of SIM cards can only be provided by a single mobile service provider for its subscribers. Under this restriction on SIM card issuing, the two directory numbers in a SIM card are provided by the same mobile service provider so that the subscribers cannot flexibly select mobile networks of different mobile service providers to make or receive a call. In order to make the multi-directory mobile stations able to access services of multiple mobile networks, the multi-directory mobile stations have to support multiple SIM cards. In the market, devices for mobile station products supporting multiple SIM cards can be divided into two types: (1) multi-SIM-slot mobile stations and (2) mobile stations with multi-SIM-slot battery. When the two types of devices are switched on, users can selectively activate one of the SIM cards and then access the selected mobile network by using the directory number of the selected SIM card. However, the two types of devices have the common disadvantage. That is, these devices activate at most one directory number from their SIM cards so that the mobile station can stand by for only one mobile network. If users desire to activate another SIM card, they have to power off and then power on their mobile stations. It is very inconvenient for the users to perform such kind of operations. Thus, these two types of devices cannot make a multi-directory mobile station with multiple SIM cards simultaneously stand by for multiple mobile networks. In other words, services of multiple mobile networks are still unavailable simultaneously for multi-directory mobile station users.

If a mobile station could simultaneously stand by for multiple mobile networks, the mobile station, when not receiving or making a call (i.e., in idle state), should perform procedures such as paging reception, location registration, and cell monitoring for the mobile networks individually in suitable instants. The mobile station needs to receive paging messages from the multiple mobile networks in order to respond to incoming calls. However, synchronization among the mobile networks may not be achieved so that paging occasions for several directory numbers of the mobile station may collide with each other. In such case, the mobile station cannot guarantee to receive all paging messages from these mobile networks completely, and this results in paging loss.

### SUMMARY OF THE INVENTION

It is therefore an object of the invention to provide a method and system for a mobile station to avoid paging loss in multiple mobile networks. In order to avoid paging loss, paging occasions for multiple directory numbers of the mobile station should not be in collision. Thus, when performing a cell selection or cell reselection procedure, a mobile station according to the invention selects the suitable cells whose paging occasions are staggered among the multiple mobile networks, and camps on the selected suitable cells, so as to receive paging messages from the mobile networks. A cell is the radio coverage area of a base station. For a specific mobile station, its suitable cell indicates the radio coverage of the base station that satisfies the following criteria:

1. The mobile station can receive a better quality radio signal from the base station; and

2. The mobile station can access normal services of the mobile network associated with the base station.

Rigor criteria for identifying suitable cells are specified in GSM 03.22.

The mobile station performs a cell selection or cell reselection procedure for the individual mobile networks in order to search for suitable cells and select one of these suitable cells as its serving cell. For example, the serving cell may be the most suitable cell having the best signal quality for the mobile station to camp on. Then, the mobile station receives information of corresponding control channels so as to access normal services from the serving cell, such as incoming call receiving and outgoing call origination. Cell selection is performed when the mobile station is switched on; on the other hand, cell reselection is performed when the mobile station has found a better cell, for example, providing higher signal quality than that by the serving cell. In short, the suitable cells that the mobile station according to the invention selects and camps on, when performing cell selection or cell reselection procedure, must meet the criteria for suitable cell as well as be staggered for paging occasions for one another.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) illustrates a single-SIM-slot mobile phone having double directory numbers.

FIG. 1B is a mobile phone having double SIM slots and having double directory numbers.

FIG. 2 illustrates a mobile communication system with two mobile networks according to an embodiment of the invention.

FIG. 3A shows a GSM time slot structure.

FIG. 3B shows a GSM control multiframe structure.

FIG. 4A is a flowchart illustrating a cell selection procedure according to the invention.

FIG. 4B is a flowchart illustrating a cell reselection procedure according to the invention.

FIG. 5 is a flowchart illustrating a procedure for confirmation of paging occasion stagger according to the invention.

FIG. 6 illustrates control channel slot stagger according to an embodiment of the invention.

FIG. 7 illustrates paging block stagger according to an embodiment of the invention.

### DETAILED DESCRIPTION OF THE INVENTION

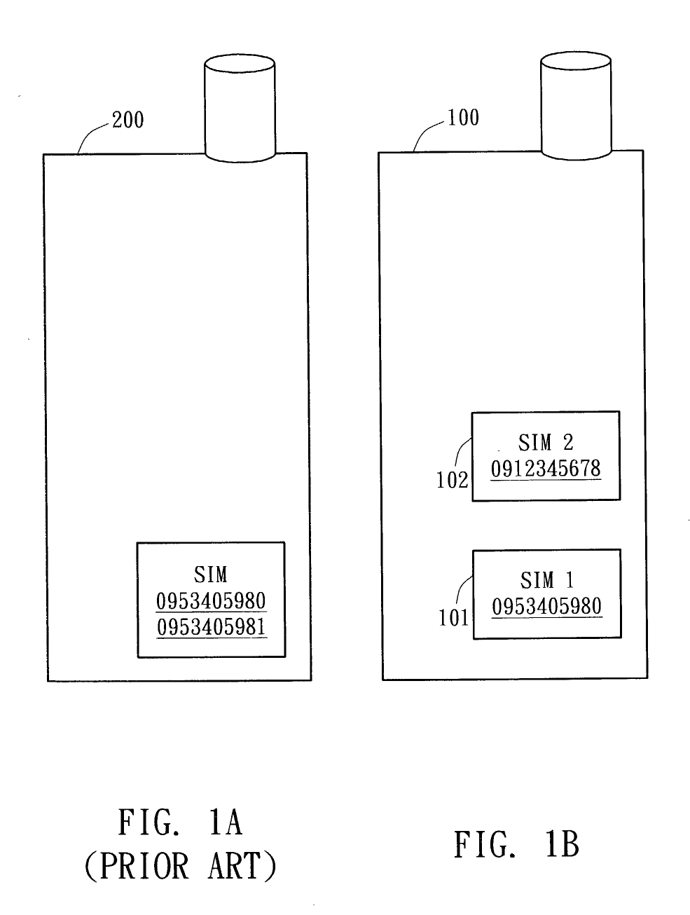

In the following embodiments according to the invention, the mobile station equipped with double SIM cards for double directory numbers simultaneously stands by for double mobile networks. FIG. 1B is a mobile phone having double SIM slots and being capable of having double directory numbers according to the invention. The mobile phone 100 has two SIM cards, for example, SIM cards 101 and 102, inserted. The SIM cards 101 and 102 store information of two directory numbers, for example, 0953405980 and 0912345678, respectively. Using the information of the directory number 0953405980 of the SIM card 101, the mobile phone 100 can access the services provided by the mobile network 0953. Using the information of the directory number 0912345678 of the SIM card 101, the mobile phone 100 can also access the services provided by the mobile network 0912. Therefore, the mobile phone 100 having two SIM cards obtains information of the two directory numbers so as to be served by two mobile networks.

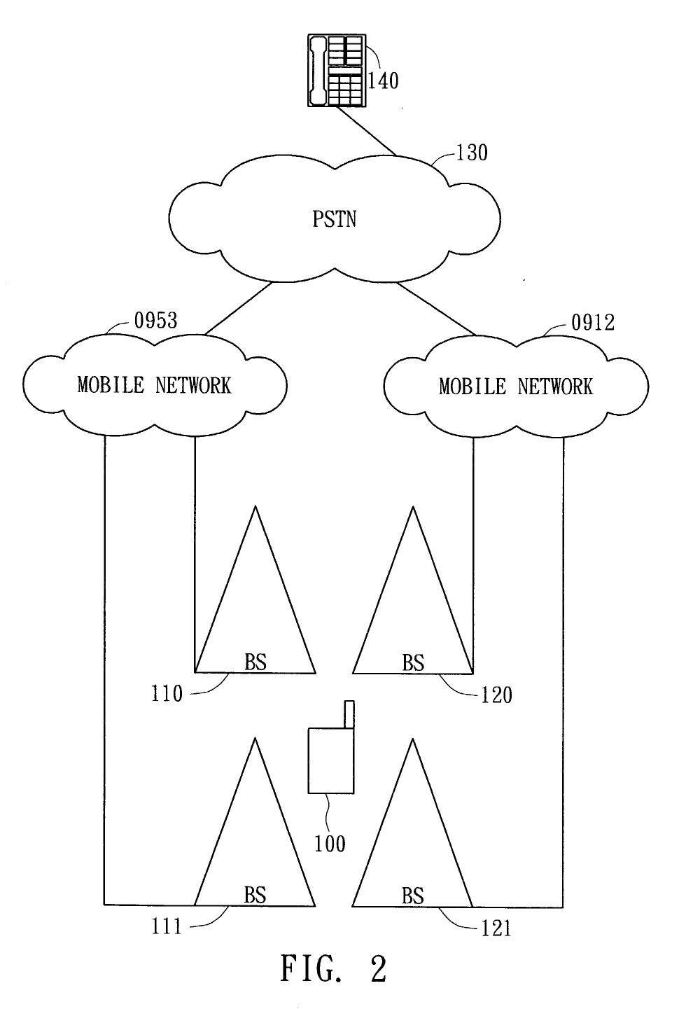

FIG. 2 illustrates a mobile communication system with two mobile networks according to an embodiment of the invention. In FIG. 2, a mobile station, such as a mobile phone 100, can receive radio signals from base stations 110, 111, 120, and 121. The base stations 110 and 111 are belonged to a mobile network 0953 while the base stations 120 and 121 are belonged to a mobile network 0912. Both the mobile networks 0953 and 0912 are connected to a public switched telephone network (PSTN) 130 so that the mobile phone 100 can establish a call to a fixed telephone 140 via the base stations, the mobile networks, and the PSTN. It should be noted that the mobile networks 0953 and 0912 are individually operating.

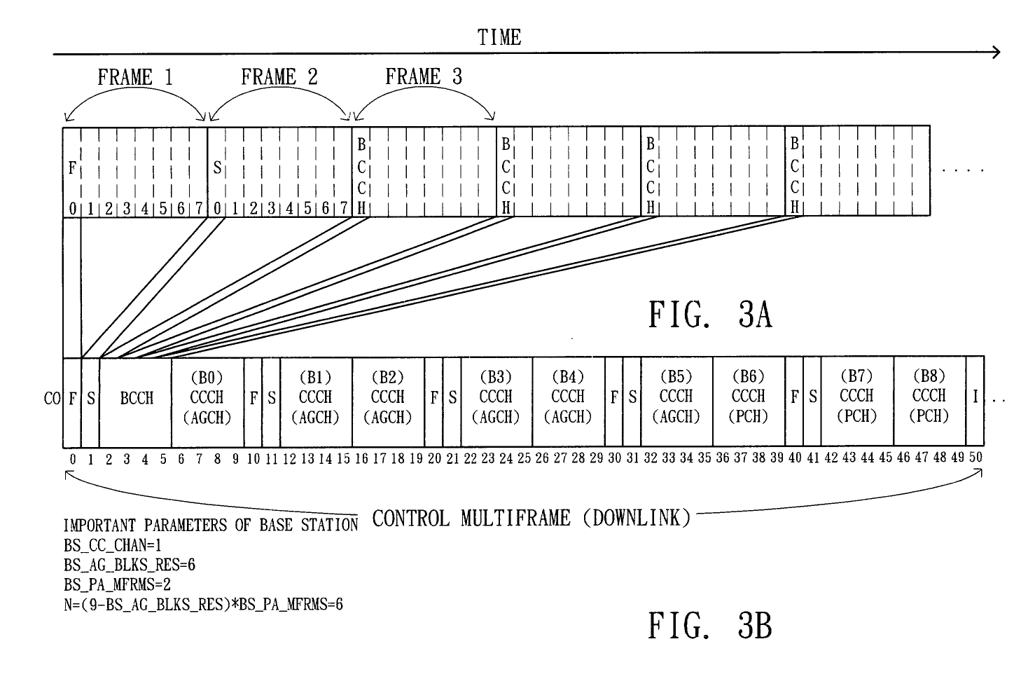

In GSM, time division multiple access (TDMA) technique is used to allocate radio channel resources and thus time slots are regarded as physical channels. FIG. 3A is a GSM time slot structure. As shown in FIG. 3A, every eight time slots form a frame and are numbered as 0 to 7, respectively. In addition, a group of identically numbered time slots on successive frames can form a multiframe. If the identically numbered time slots are used to convey user data, the identically numbered time slots on every 26 successive frames can form a traffic multiframe. If control commands are conveyed, the identically numbered time slots on every 51 successive frames can form a control multiframe. For example, a control multiframe as shown in FIG. 3B is formed by zero-numbered time slots on 51 successive frames.

As shown in FIG. 3B, the control multiframe includes four control channels: (1) frequency correction channel (FCCH), shortened as F in FIG. 3B, (2) synchronization channel (SCH), shortened as S in FIG. 3B, (3) broadcast control channel (BCCH), and (4) common control channel (CCCH). FCCH provides information for the mobile station to lock the frequency of the control channel. SCH provides information for the mobile station to perform frame synchronization. SCH information includes base station transceiver identity code (BSIC) and reduced TDMA frame number. Using SCH information, the mobile station can determine which base station the control channel belongs to and which numbered frame the control channel is currently referred to. BCCH provides system information about the base station for the mobile station. Broadcasting occasions are assigned to the identically numbered time slots on frame number 2 to frame number 5 for the control multiframe. The system information has some important parameters such as BS_CC_CHAN message, BS_AG_BLKS_RES message, and BS_PA_MFRMS message. Specifically, BS_CC_CHAN message indicates number of basic physical channels supporting common control channel of the base station. BS_AG_BLKS_RES message indicates number of blocks on the control channel reserved for access grant channel (AGCH). BS_PA_MFRMS message indicates number of multiframes between two transmissions of the paging messages to mobile stations of the same paging group. In GSM, a downlink CCCH includes AGCH and paging channel while an uplink CCCH includes random access channel (RACH). Each control multiframe has nine CCCH blocks (i.e., B0 to B8 as shown in FIG. 3B) and each of the blocks is formed by the identically numbered time slots in four successive frames. In FIG. 3B, according to the embodiment, the first six CCCHs are AGCHs, as indicated by B0 to B5, and the other three CCCHs are paging channels (PCHs), as indicated by B6 to B8, wherein BS_AG_BLKS_RES is equal to 6 and the number of PCHs is 9-BS_AG_BLKS_RES=3. According to the above information, number of paging groups of the base station is N, where N=(9-BS_AG_BLKS_RES)*BS_PA_MFRMS. It should be noted that GSM control channels are not limited to the above four types. For detailed information on GSM control channels, please refer to standard documents for GSM 05.02. In addition, according to GSM 05.02, a paging occasion of a mobile station with an international mobile subscriber identity (IMSI) is on the paging group PAGING_GROUP of the control channel CCCH_GROUP, wherein parameters CCCH_GROUP and PAGING_GROUP are related by:

CCCH_GROUP=((IMSI mod 1000) mod (BS_CC_CHANS*N)) div N, and

PAGING_GROUP=((IMSI mod 1000) mod (BS_CC_CHANS*N)) mod N.

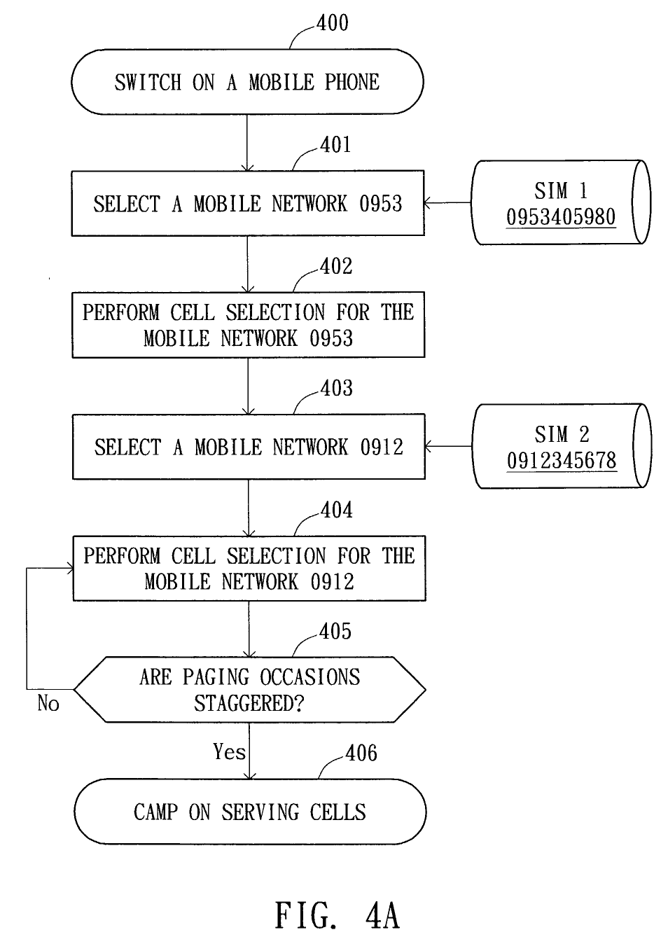

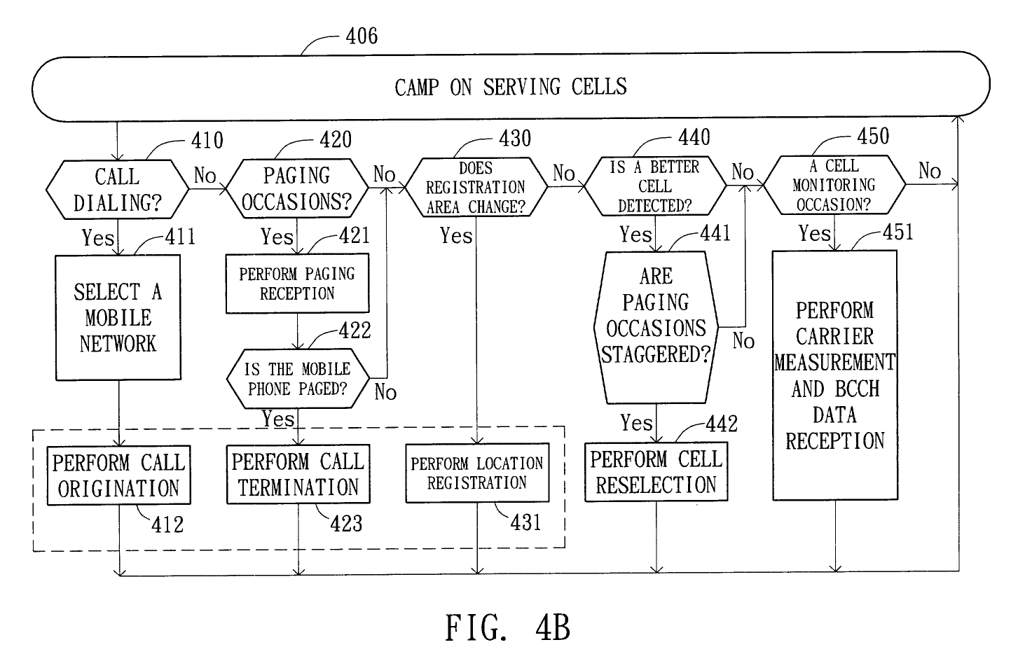

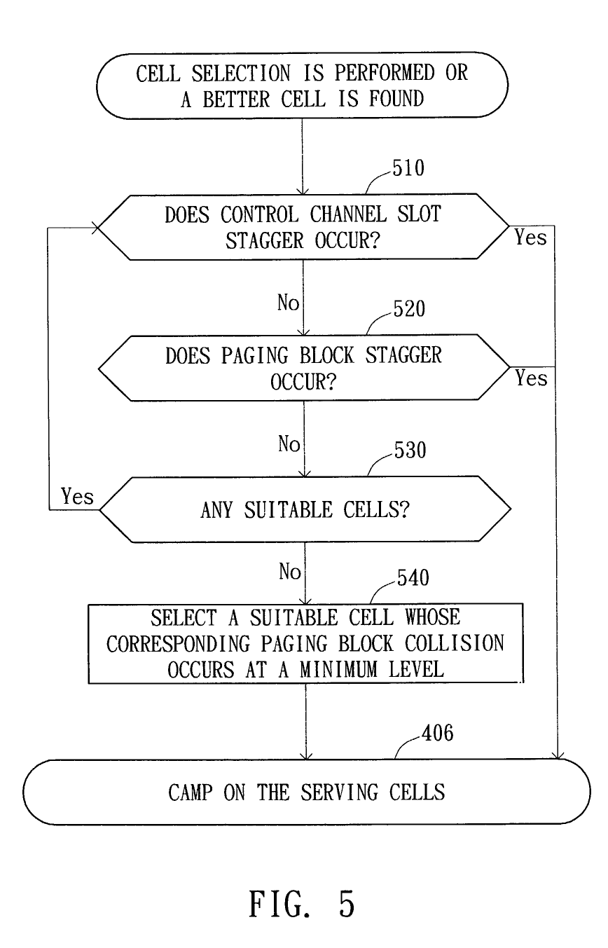

It is desired to make a mobile station simultaneously stand by for multiple mobile networks and make the mobile station avoid paging loss. Thus, when performing a cell selection procedure, as illustrated in FIG. 4A, or a cell reselection procedure, as in FIG. 4B, a mobile station according to the invention selects suitable cells whose paging occasions are staggered among the multiple mobile networks and camps on the selected suitable cells, as in FIG. 5, so as to receive paging messages from the mobile networks. For a specific mobile station, its suitable cell indicates the radio coverage of the base station that satisfies the following criteria: (1) the mobile station can receive a better quality radio signal from the base station; and (2) the mobile station can access normal services of the mobile network associated with the base station. Rigor criteria for identifying suitable cells are specified in GSM 03.22. FIG. 4A is a flowchart illustrating a cell selection procedure according to the invention. When the mobile phone 100 is switched on, as indicated in step 400, the mobile phone 100 activates the first SIM card to obtain information on directory number 0953405980 and then the mobile network 0953 is selected by the subscriber manually or the mobile phone 100 automatically, as in step 401. In order to camp on a serving cell of the mobile network 0953 and receive information from the mobile network 0953, the mobile phone 100 needs to perform cell selection for the mobile network 0953, as in step 402. Next, the mobile phone 100 activates the second SIM card to obtain information on directory number 0912345678, selects the mobile network 0912, as in step 403, and selects a suitable cell of the mobile network 0912, as in step 404. After that, the mobile phone 100 determines whether the paging occasions of the suitable cells selected in steps 404 and 402 are staggered, as indicated in step 405. If so, the mobile phone 100 camps on the selected suitable cells, which are referred to as serving cells, as indicated in step 406. If not, the procedure proceeds to step 404 (or step 402) to perform cell selection for the mobile network 0912 (or mobile network 0953) until a paging occasion stagger is found between a suitable cell of the mobile network 0912 and the selected suitable cell of the mobile network 0953 in step 402.

FIG. 4B is a flowchart illustrating a cell reselection procedure according to the invention. After camping on the serving cells, as in step 406, the mobile phone 100 is capable of listening to these serving cells' control channels and performs corresponding procedures according to different events. These events include, for example, call dialing, paging reception, registration area change, better cell detection, and cell monitoring. In step 410, it is determined whether a call dialing event occurs. If so, a mobile network is selected, as indicated in step 411, and call origination is performed; that is, a call is originated from the mobile phone 100 to the selected mobile network, as indicated in step 412. In step 420, it is determined whether any paging occasions for any mobile network occur. If so, paging reception is performed, as indicated in step 421, and then step 422 is performed. In step 422, it is determined whether the mobile phone 100 is paged. If so, call termination is performed, as indicated in step 423; if not, the procedure continues to wait for other events. In step 430, it is determined whether the movement of the mobile phone 100 causes any registration area changes for any mobile network. If so, location registration for the mobile network that registration area changes is performed, as indicated in step 431. Next, in step 440, it is determined whether a better cell, for example, a cell providing higher signal quality than that by the serving cell, is detected. If so, it is determined whether the paging occasions of the better cell and paging occasions of serving cells of other mobile networks are staggered, as indicated in step 441. If the paging occasions are staggered, cell reselection is complete, as indicated in step 442, and step 406 is then executed, wherein the mobile phone 100 is to camp on the better cell that is detected in step 440 previously and the better cell becomes a serving cell. If the above-mentioned events, as in steps 410, 420, 430, and 440, do not occur, it is determined whether a cell monitoring occasion occur, in step 450. If so, the mobile phone 100 finds time in the cell monitoring occasion to perform carrier measurement and BCCH data reception, as indicated in step 451. It should be noted that according to GSM 05.08, carrier measurement and BCCH data reception are performed before flexible extended deadlines. For example, each carrier should be measured for 5 samples every second, and all BCCH data of serving cells must be updated within every 30 seconds, and BCCH data of six non-serving cells for cell reselection should be updated within every 5 minutes. Thus, under appropriate task scheduling, cell monitoring would not interfere with a paging reception occasion.

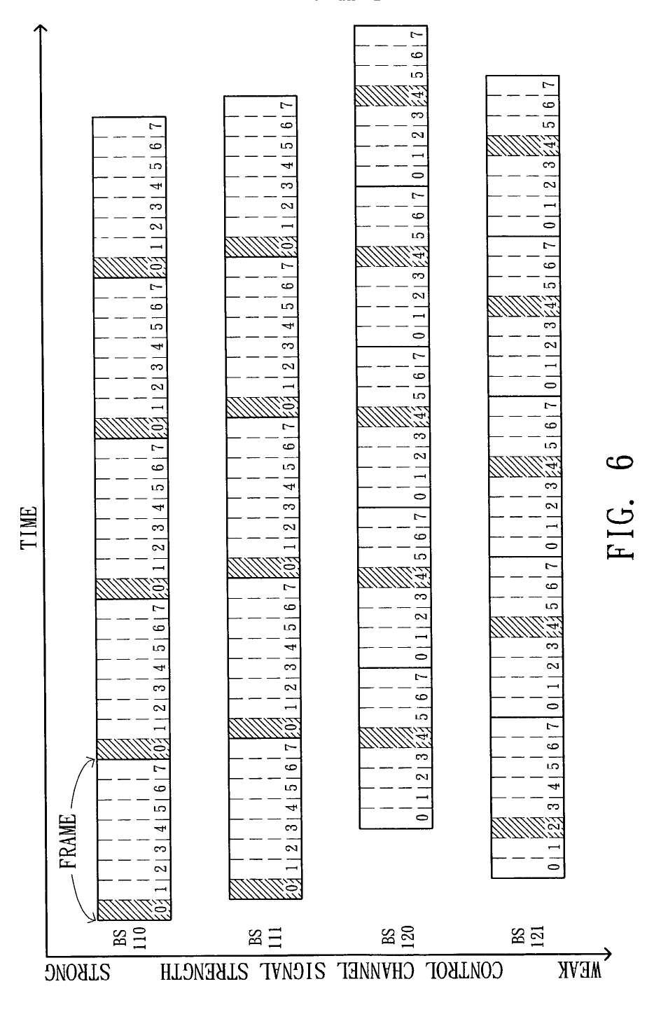

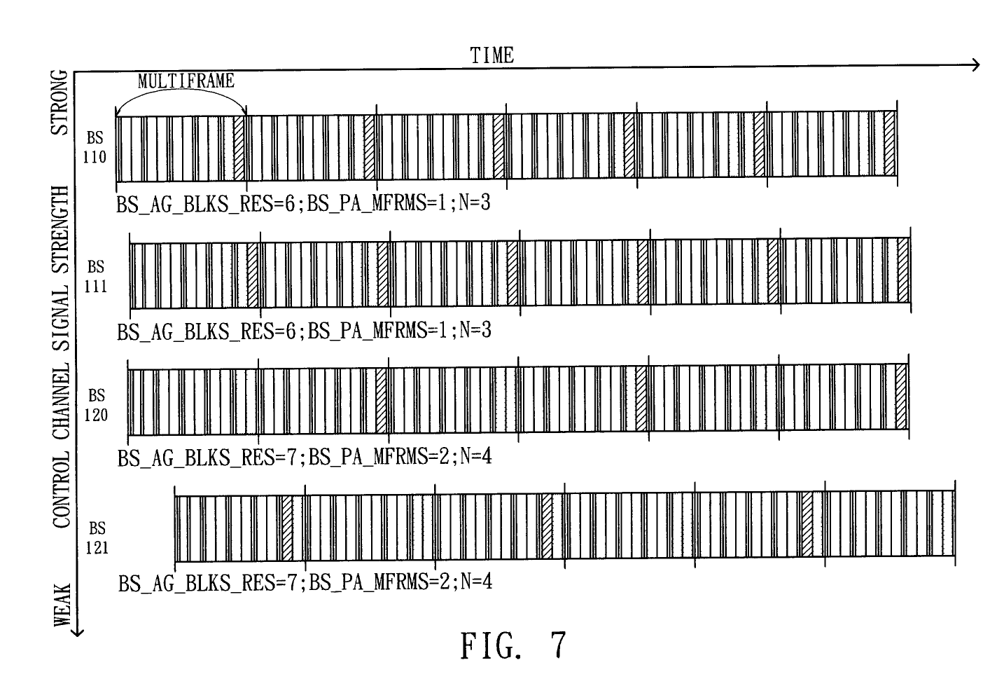

In step 405 of FIG. 4A and step 441 of FIG. 4B, the cellular system according to the invention needs to determine whether the paging occasions of the selected suitable cells are staggered, according to the received system information of the base station. Paging occasion stagger can be classified into control channel slot stagger and paging block stagger. Control channel slot stagger indicates that no collision occurs between control channel slots of two suitable cells, which will be explained with FIG. 6. Paging block stagger indicates that no collision occurs between paging blocks on the control channels of two suitable cells, which will be explained with FIG. 7. On the other hand, it is possible that paging occasions of all suitable cells of two mobile networks are not staggered completely. In such case, during either cell selection or cell reselection, the suitable cells of the mobile networks whose corresponding paging blocks collide at a minimum level per unit time are to be selected.

FIG. 5 is a flowchart illustrating a detailed procedure for confirmation of paging occasion stagger according to the invention. The procedure includes the following steps. After cell selection is performed, as indicated in step 404, or a better cell is found, as in step 440, a determination is made as to whether control channel slot stagger occurs, as in step 510. If control channel slot stagger occurs, the mobile station camps on a serving cell, such as the suitable cell selected in step 404 or the better cell found in step 440, as indicated in step 406. If not, the procedure proceeds to step 520. In step 520, it is determined whether paging block stagger occurs. If paging block stagger occurs, the mobile station camps on the serving cell, as indicated in step 406; if not, step 530 is executed. In step 530, it is determined whether there are any other suitable cells. If so, the procedure proceeds to step 510; if not, step 540 is executed. In step 540, a suitable cell whose corresponding paging blocks collide at a minimum level is selected. The suitable cell is then camped on as a serving cell, as indicated in step 406. Further, a mobile station according to the invention can include a controller and a radio frequency (RF) receiver coupled to the controller, for example. The controller can be used to select suitable cells from multiple mobile networks as serving cells to camp on during cell selection or cell reselection, wherein paging occasion stagger occurs on corresponding paging occasions of the serving cells. The RF receiver is used to receive paging messages from the mobile networks. Note that after the mobile station camps on serving cells of two different mobile networks, the RF receiver of the mobile station needs to perform frequency switching alternately for access to two corresponding base stations. Thus, for determining whether either control channel slot stagger or paging block stagger occurs, the time for frequency switching should be considered.

FIG. 6 illustrates control channel slot stagger according to one embodiment of the invention. FIG. 6 illustrates that the mobile phone 100 listens to the control channel slots of the base stations 110, 111, 120, and 121, as indicated by the respective areas filled with oblique lines. As described above, the base stations 110 and 111 belong to the mobile network 0953 while the base stations 120 and 121 belong to the mobile network 0912. When searching for suitable cells according to channel signal strength, the mobile phone 100 first selects the mobile network 0953 and its base station 110 as a suitable cell. Next, the base station 111 is found. Since the base stations 111 and 110 belong to the same mobile network, the mobile phone 100 proceeds to search other base stations. The base station 120 is then found. However, since it is determined that the control channel slots of the base station 120 and that of the base station 110 collide completely, the mobile phone 100 proceeds to search other base stations. When the base station 121 is found, it is determined that the base station 121 belongs to the mobile network 0912. In addition, the control channel slots of the base station 121 and that of the previously selected base station 110 are staggered. Thus, the mobile phone 100 camps on the base stations 110 and 121 as the serving cells so as to simultaneously stand by for the mobile networks 0953 and 0912.

If corresponding control channel slots of all suitable cells of the two mobile networks are not staggered, the occurrence of paging block stagger is to be detected. FIG. 7 illustrates paging block stagger according to one embodiment of the invention. Suppose that control channel slot stagger does not occur on the base stations 110, 111, 120, and 121. The multiframes of the base stations 110, 111, 120, and 121 are shown in FIG. 7, respectively, wherein on their respective multiframes, the stippled areas indicate corresponding paging channel blocks of the base stations, and the areas filled with oblique lines indicate corresponding paging blocks of the mobile station for respective base stations. When searching for suitable cells according to channel signal strength, the mobile phone 100 first selects the mobile network 0953 and its base station 110 as a suitable cell. Next, the base station 111 is found. Since the base stations 111 and 110 belong to the same mobile network, the mobile phone 100 proceeds to search other base stations. The base station 120 is then found. However, since it is determined that the paging blocks of the base station 120 and that of the base station 110 collide completely, the mobile phone 100 proceeds to search other base stations. When the base station 121 is found, it is determined that the base station 121 belongs to the mobile network 0912. In addition, the paging occasions of the base station 121 and that of the previously selected base station 110 are staggered. Thus, the mobile phone 100 camps on the base stations 110 and 121 as the serving cells so as to simultaneously stand by for the mobile networks 0953 and 0912.

While the invention has been described by way of example and in terms of a preferred embodiment, it is to be understood that the invention is not limited thereto. The mobile station in the embodiment has two SIM cards and two directory numbers, and simultaneously stands by for two GSM mobile networks. In addition, according to the invention, a mobile station can have at least two SIM cards, at least two directory numbers, or can be used in at least two or more mobile networks. In this way, users' requirements for multi-directory mobile phones can be satisfied. Further, according to the invention, a mobile phone system can be made to simultaneously stand by for not only the same type of GSM mobile networks, but also different types of mobile networks, such as GSM and general packet radio service (GPRS) hybrid network, 802.11 wireless local area network (WLAN) and GPRS hybrid network. It is intended to cover various modifications and similar arrangements and procedures, and the scope of the appended claims therefore should be accorded the broadest interpretation so as to encompass all such modifications and similar arrangements and procedures.

What is claimed is:

1. A system for a mobile station to avoid paging loss in multiple mobile networks, the system comprising:
a first mobile network;
a second mobile network; and
a mobile station capable of receiving paging messages from a plurality of serving cells by selecting at least a first suitable cell of the first mobile network and a second suitable cell of the second mobile network as the serving cells wherein paging occasion stagger occurs on paging occasions of the serving cells, whereby the mobile station avoids paging loss in at least the first and second mobile networks.

2. The system according to claim 1, wherein the paging occasion stagger is control channel slot stagger, which indicates that corresponding control channel slots of the serving cells are staggered.

3. The system according to claim 1, wherein the paging occasion stagger is paging block stagger, which indicates that paging blocks on corresponding control channels of the serving cells are staggered.

4. The system according to claim 1, wherein the mobile station includes a subscriber identity module.

5. The system according to claim 1, wherein both the first mobile network and the second mobile network use a mobile communication technology.

6. The system according to claim 5, wherein the mobile communication technology is global system for mobile communications (GSM) technology.

7. The system according to claim 1, wherein the first mobile network and the second mobile network use different mobile communication technologies.

8. The system according to claim 7, wherein the first mobile network uses global system for mobile communications (GSM) technology, and the second mobile network uses general packet radio service (GPRS) technology.

9. The system according to claim 7, wherein the first mobile network uses general packet radio service (GPRS) technology, and the second mobile network uses wireless local area network (WLAN) technology.

10. A method for a mobile station to avoid paging loss in multiple mobile networks, the method comprising the steps of:
selecting a first suitable cell by performing cell selection for a first mobile network;
selecting a second suitable cell by performing cell selection for a second mobile network;
determining whether paging occasion stagger occurs on paging occasions of suitable cells including the first suitable cell and the second suitable cell; and
if so, camping on the suitable cells whose paging occasions are determined to be staggered, which are defined as serving cells;
whereby the mobile station avoids paging loss in the serving cells.

11. The method according to claim 10, wherein the step of determining whether paging occasion stagger occurs comprises the step of:
determining whether control channel slot stagger occurs on paging occasions of the first suitable cell and paging occasions of the second suitable cell, wherein the control channel slot stagger indicates that corresponding control channel slots of the first and the second suitable cells are staggered.

12. The method according to claim 10, wherein the step of determining whether paging occasion stagger occurs comprises the step of:
determining whether paging block stagger occurs on paging occasions of the first suitable cell and paging occasions of the second suitable cell, wherein the paging block stagger indicates that paging blocks on corresponding control channels of the first and the second suitable cells are staggered.

13. The method according to claim 10, wherein the step of determining whether paging occasion stagger occurs is performed when a better cell is detected.

14. The method according to claim 13, wherein the step of determining whether paging occasion stagger occurs comprises the step of:
determining whether paging occasions of the better cell and paging occasions of serving cells are staggered.

15. The method according to claim 10, wherein both the first mobile network and the second mobile network use a mobile communication technology.

16. The method according to claim 15, wherein the mobile communication technology is global system for mobile communications (GSM).

17. The method according to claim 10, wherein the first mobile network and the second mobile network use different mobile communication technologies.

18. The method according to claim 17, wherein the first mobile network uses global system for mobile communications (GSM) technology, and the second mobile network uses general packet radio service (GPRS) technology.

19. The method according to claim 17, wherein the first mobile network uses general packet radio service (GPRS) technology, and the second mobile network uses wireless local area network (WLAN) technology.

20. A mobile station capable of avoiding paging loss in multiple mobile networks including a first mobile network and a second mobile network, the mobile station comprising:
means for selecting at least a first suitable cell of the first mobile network and a second suitable cell of the second mobile network to camp on during cell selection or cell reselection, wherein paging occasion stagger occurs on paging occasions for the first suitable cell and paging occasions for the second suitable cell; and
a radio frequency receiver, couple to the selecting means, to receive paging messages from at least the first and second suitable cell;
whereby the mobile station avoids paging loss in at least the first suitable cell and the second suitable cell.

21. The mobile station according to claim 20, wherein the paging occasion stagger is control channel slot stagger, which indicates that corresponding control channel slots of the first and the second suitable cells are staggered.

22. The mobile station according to claim 20, wherein the paging occasion stagger is paging block stagger, which indicates that paging blocks on corresponding control channels of the first and the second suitable cells are staggered.

23. The mobile station according to claim 20, wherein the mobile station includes a subscriber identity module.

24. The mobile station according to claim 20, wherein both the first mobile network and the second mobile network use a mobile communication technology.

25. The mobile station according to claim 24, wherein the mobile communication technology is global system for mobile communications (GSM).

26. The mobile station according to claim 20, wherein the first mobile network and the second mobile network use different mobile communication technologies.

27. The mobile station according to claim 26, wherein the first mobile network uses global system for mobile communications (GSM) technology, and the second mobile network uses general packet radio service (GPRS) technology.

28. The mobile station according to claim 26, wherein the first mobile network uses general packet radio service (GPRS) technology, and the second mobile network uses wireless local area network (WLAN) technology.
